(19) United States
(12) Patent Application Publication
(10) Pub. No.: US 2005/0029196 A1
(43) Pub. Date: Feb. 10, 2005

(54) Packing materials for separation of biomolecules

(75) Inventor: Maria Martha Rhemrev-Boom, Nijeveen (NL)

Correspondence Address: WEINGARTEN, SCHURGIN, GAGNEBIN & LEBOVICI LLP, TEN POST OFFICE SQUARE, BOSTON, MA, 02109, US

(73) Assignee: RESQ LAB B.V.

(21) Appl. No.: 10/883,211

(22) Filed: Jul. 1, 2004

Related U.S. Application Data
(62) Division of application No. 10/203,581, filed on Nov. 19, 2002.

(51) Int. Cl. B01D 15/08

(52) U.S. Cl. 210/656; 210/198.2; 210/502.1; 436/161; 422/70

(57) ABSTRACT

The invention relates to the field of separation of molecules, in particular biomolecules, from media containing said molecules. The invention provides a sorbent for use in separation of molecules, comprising a, preferably crosslinked, polymer coating (to prevent non-selective adsorption, preferably having been provided with a spacer molecule and/or a functional moiety to allow coupling of an affinity ligand.

This application is a divisional application under §1.53(b) of prior application Ser. No. 10/203,581 filed Nov. 19, 2002, which was a §371 filing of PCT/NL00/00078 filed Feb. 9, 2000.

The invention relates to the field of separation of molecules, in particular biomolecules, from media containing said molecules.

Biological materials (comprising, found in or originating from living cells) comprise a great variety of molecules. Central molecules are nucleotides and polymers thereof, including nucleic acids (DNA and RNA); and amino acids, and polymers thereof, such as peptides and proteins, constituting the machinery of a cell, by which many other molecules, such as carbohydrates and multimers thereof, lipids and lipid complexes, hormones, vitamins, co-factors, and so on are produced.

Central to life is the interaction between these molecules based on specific binding or affinity, and modification of the affinity by modification of the environment. Complementary DNA strands wind together when incorporated in a resting genome; however unwind when in the process of replication or translation.

Ribosomal proteins adhere to strands of nucleic acid when translating these in newly produced proteins. Newly produced proteins for example act as enzyme, by having affinity and thus by binding to its specific substrate. After enzymatic modification of the substrate the affinity or binding capacity for the resulting reaction product is in general less, and the reaction product is released.

Other types of protein become integrated in the outer layer of a cell, and act there for example as ion- or molecule-pump, having affinity for (and thus bind), e.g., a nutrient or waste product. After channeling it through the membrane the affinity for the nutrient or waste product is again reduced and the said product is released again. Free floating cytoplasmic receptor proteins act as subsequent transporting means, binding a product at one side and releasing it at another side of the cell, again based on affinity interaction.

Yet other proteins interact with other molecules, such as peptides, co-factors, metal-ions, to form functional protein complexes, such as major or minor histo-compatibility complexes that comprise peptides that are presented to yet other receptor proteins recognizing the thus formed peptide-protein complex. Foreign antigens invading an organism get recognized and bound by antibodies formed by cells of said organism in mounting an immune response. Said antibodies can be detected in diagnostic assays because they have a specific affinity for the disease antigens in question. Above examples all relate to interactions between molecules based on their mutual affinity. Such interactions are not necessarily only occurring between biological molecules only. Receptor proteins, such as hormone receptors, can also have affinity for synthetic organic molecules, such as synthetic hormones. Synthetic nucleic acid analogues, such as peptide nucleic acids (PNA) have been produced that mimic binding of DNA or RNA. Antibodies can bind to haptens, small, even inorganic molecules, for which said antibody has affinity. Synthetic compounds are known that influence biological molecule action, and thus life's processes, by affinity interaction. Current drug development programs focus mainly on the detection of molecules that can specifically interact somewhere in a cascade of molecular events seen with (patho)-physiological processes in the cell, and thus focus on molecules having specific affinity for the said molecular events.

Central to the study of molecules are specific methods to separate distinct or desired molecules from among many other, non-related molecules. Such separation techniques, comprising for example isolation, purification and/or concentration, often make use of the above described, specific affinity between molecules. In such separation methods, mixtures or, in general liquid media potentially comprising desired molecules, albeit mixed with other, non-desired molecules are led through or treated in separation units comprising active surfaces coated with affinity ligands specific for the desired molecule.

For example, when desiring to purify a distinct protein from a mixture by affinity separation, the mixture can be mixed or contacted with a sorbent or carrier coated with antibodies that are specific for the desired protein, the antigen (see, e.g.: Molecular Cell Biology, Darnell, Lodish and Baltimore, Freeman and Company, 1990). Only that protein binds to the antibody and is thus retained at the sorbent or carrier, any other proteins do not bind and can be washed off or be eluted.

In a following step, a suitable eluent, such as an acetic acid solution is added to disrupt the antigen-antibody complex, so that a pure protein can be washed off or eluted from the sorbent or carrier.

In another example (see, e.g.: Molecular Cell Biology, Darnell, Lodish and Baltimore, Freeman and Company, 1990), purification of a beta-adrenergic receptor can be achieved by binding a potent receptor-binding antagonist such as alprenolol by chemically linking it to polystyrene beads. A crude, detergent solubilized preparation is passed through a column containing these beads. Only the receptor binds to the beads; the other proteins are washed through by excess fluid. On the addition of an excess alprenolol to the column, the bound receptor is displaced from the beads and eluted by competitive binding to the free alprenolol.

Above examples illustrate that in the selective separation (isolation, concentration, purification) of compounds of interest, (immuno)affinity separation, in particular affinity chromatography is a most powerful technique. If used on-line with other modes of separation chromatography, advantages of both modes are easily combined. However, although a variety of sorbents, herein also called solid phase supports or carriers, are commercially available for the purpose of (immuno)affinity separation chromatography, in combination with for example High Performance Liquid Chromatography, just a few rigid materials (for instance the polystyrene matrices) can be applied. These materials are relatively expensive and in some applications show non-selective adsorption.

Affinity separation is thus is a powerful technique for isolating and concentrating components of interest from a more or less complex mixture. It offers the possibility of separating substances from complex samples with a selectivity which cannot be achieved by other methods. This selectivity is derived from the use of a solid phase support comprising an affinity ligand, such as a specific nucleic acid (DNA, RNA or PNA), a specific glycan, a native or synthetic proteinaceous binding molecule such as a (poly)peptide, a receptor, enzyme, a (synthetic) antibody molecule, a specific antigen or hapten, or any other specific binding molecule.

Ideally, in affinity chromatography, a sample passed over or led through an affinity column, separates into two bands or fractions. The first band elutes with a capacity ratio k′=0 and contains all the compounds which do not bind to the affinity ligand. The second band, containing only the desired compound or analyt, is bound by the ligand and thus retained. By changing the mobile phase, e.g. by decreasing pH, increasing ionic strength, incorporating chaotropic compounds, or modifying other suitable parameters causes the analyt peak to elute. Analytical applications in general require that only the analyt be retained on the column (high selectivity, low non-specific adsorption) and that the separation takes place in a minimum amount of time (short retention times, high chromatographic efficiencies).

Although above explained biospecific immunoaffinity chromatography is a common technique in most areas of biomedical research, the application of two-dimensional chromatography, in which immunoaffinity chromatography is combined with other modes of chromatography, for instance high performance liquid chromatography (HPLC), is relatively new. In this case the immunoaffinity column is used for the selective isolation and pre-concentration of the analyt of interest, whereas quantitative analysis is performed by HPLC. Via this way the advantages of both techniques are combined: it allows easily automatic determination of large amount of samples; fast analysis per sample compared to conventional plate immunoassay; high sensitivity and selectivity; it is accurate; allows good recoveries and no cross-reactivity thanks to additional separation and reproducible determination (1-2% Relative Standard Deviation) of the analyt of interest; it provides easy direct calibration; and has low material costs and waste compared to plate immunoassays.

However, regarding the type of solid phase support or sorbents used in these types of applications specific criteria have to be met. Not only has the support to be mechanically and physically stable and in general needs to be a hydrophilic solid phase support, but also other parameters have to be considered, such as particle size, pore-size distribution, available specific area and polymer flexibility to achieve high ligand accessibility. Non-specific adsorption and interaction should be avoided at all times. In addition, in order to withstand the high pressures normally present at for example HPLC applications, the solid phase support has preferably to be a rigid material.

In order to provide solid phase supports or packing materials for the purpose of the purification, selective isolation or concentration optionally in combination with liquid chromatographic techniques, sorbents or packing materials and/or solid phase supports continue to be developed with improved chemical and mechanical stability and/or chromatographic performances. Although conditions have to be optimised for each application, some common criteria dictate the selection of the supports. First, they should be chemically and physically stable, and possess good mechanical strength to allow high flow rates. These conditions are in general met by inorganic sorbents such as silica or glass or metal oxides comprising for example alumina, zirconium or titanium. Next, they should not contain groups that bind the compounds of interest non-specifically, but should be easily derivatizable to allow the introduction of functional groups for interactive chromatographic applications. However, in general, the inorganic sorbents show high non-specific binding or adsorption. Furthermore, their ability to withstand regeneration and cleaning procedures is also an important parameter. Furthermore, they should be produced with controllable size and pore size distribution and should be reproducible from batch to batch. Low cost, maximum throughput and high selectivity are important considerations.

A wide variety of materials, including organic and inorganic polymers, have been used for the design of solid phase supports. New surface derivatization procedures have been introduced in order to control non-specific adsorption and to provide new ligands with enhance selectivity and resistance to hydrolysis. Packing materials can also be classified according to their structure. They can be divided into non-porous or porous. The terms rigid, semi-rigid or soft packings are related to their mechanical strength, which depends strongly on their ability to shrink or swell in the presence of certain solvents. Soft gels exhibit poor mechanical stability and can withstand pressures up to 3-5 bar only. Semi-rigid materials can be operated under medium pressure (15-30 bar), whereas rigid materials can be operated under high pressure (200-300 bar) and thus allow application in the traditional high performance liquid chromatographic techniques. In most cases, a description of column packing materials or sorbents includes two aspects: the base support or core and a stationary phase or coating that is chemically or physically immobilised on the core and carries the necessary functions. A packing material generally comprises a base support (core or carrier) supporting the stationary phase which is in equilibrium with the mobile phase. The stationary phase might be the support itself or an interfacial layer or coating.

Numerous packing materials, mostly those based on hydrophilic polymers, are produced by linking the functional moieties onto the core. In contrast, composite materials are obtained by coating a non-inert core particle with a polymeric layer prior to the introduction of functional groups. The base support plays a dominant role in the mechanical, chemical and thermal stability of packing materials. Ideally, a coating for a packing material should be chemically resistant and should effectively shield the core from solvent degradation or non-specific interactions with the compound of interest.

The first organic polymers to attract interest for packing materials were natural polysaccharides, including agarose, cellulose, cross-linked dextran and, to a lesser extent, cross-linked amylose and starch. These materials are produced with a suitable porosity, are stable over a wide range (pH 3-13) and are able to withstand alkaline washing. In addition, they possess a high content of hydroxyl groups available for activation and derivatization, they are hydrophilic and generally do not interact with proteins. However, under extreme conditions they may exhibit weak ionic or hydrophobic properties. The main drawback of polysaccharides is their poor mechanical strength related to their swelling ability. Although the mechanical stability of cellulose or agarose particles can be improved to a certain extend by chemical cross-linking, evidence exists that cross-linking may lead to undesirable interactions with for instance proteins.

Other organic materials are based on synthetic polymers, like the polyacrylamides, polyacrylates and polyvinyl polymers. Their main advantage is their pH stability. Furthermore, most of them are more resistant to pressure than polysaccharides.

Disadvantages in comparison to inorganic materials are lower pressure tolerance, swelling changes that may occur in the presence of organic solvents, broader pore-size distributions and decreased efficiency. Next, because of the hydrophobic character of e.g. the polyvinyl polymers, direct use in biochromatography is limited, due to, in most cases, undesirable non-specific interactions with the compound of interest, and surface modification must be used to increase their polarity.

Undoubtedly, silica is the most widely used chromatographic material being available in a wide range of particle sizes and porosities. Silica is very stable under pressure and can easily be derivatized to introduce functional ligands. However, silica is unstable at mild alkaline pH values and dissolves drastically above pH 8. Furthermore, due to not fully protected silanol-groups at the silica surface after silanisation, non-specific reactions occur between these deprotonated silanol groups and the basic parts of for instance biomolecules. Other rigid material inorganic sorbents (controlled pore) glass or metal oxides comprising for example alumina, zirconium or titanium can be used, however, due to a diversity of disadvantages in relation to silica their application is not as widespread. In addition, also these materials exhibit non-selective adsorption and are therefor in general not applicable for most applications where separation of biomolecules is involved.

Because the base support plays a dominant role in the mechanical, chemical and thermal stability of packing materials, other materials were introduced by coating a non-inert core particle with a polymeric layer prior to the introduction of functional groups. Based on the need for packing materials with higher separation efficiencies for the separation of proteins by means of ion exchange, much work has been conducted on the development of ion exchange materials based on silica particles with pore diameters of 400-1000 nm. Although the access of large molecules to the internal surface of these supports improves via this way, the capacity for small molecules drastically decreases. Another disadvantage of using particles with large pore diameters is the mechanical stability of the support. Frequently, it is seen that the lifetime of such a chromatographic column is limited due to the formation of ‘fines’.

In short, there is an on-going need for packing materials or sorbents that combine high mechanical strength and good chemical stability with a high capacity and selectivity. In addition, new strategies need to be developed to link different functional moieties and to provide adequate ligand accessibility.

The invention provides a packing material comprising an anorganic sorbent, such as silica, controlled pore glass or, preferably, a metal oxide, such as alumina, zirconia, thoria or titania, or hydroxyapatite, for use in separation of molecules, such as by (immuno)affinity, by ion exchange, or by hydrofobic interaction separation, by chiral separation, or for example in reversed phase chromatography, wherein said sorbent has been provided with a polymer coating to prevent non-selective adsorption, which polymer has preferably been cross-linked and which preferably also has been provided with a spacer to provide maximum motional freedom and therefor the best adaptation towards adsorbing proteins or other molecules, said spacer comprising a coupling site.

Herein hydrophobic interaction chromatography (HIC) is defined as a type of affinity chromatography involving the association of lipophilic regions of the component of interest and hydrophobic ligands (butyl, octyl and phenyl groups as well as pentyl, hexyl, dodecyl, palmityl and naphthoyl and trityl groups have been reported) immobilised on the support. The hydrocarbon regions which are responsible for the hydrophobic character are either aliphatic or aromatic or both and possess the common properties of excluding water and forming a hydrophobic association. Hydrophobic interactions are relatively strong and their strength is dependent on the nature of the molecule and can be influenced by salt concentration and by temperature. The adsorption of the component of interest is generally performed at high ionic strength (1-3 M), while a decreasing salt gradient is used to elute the components from the column.

Ionexchange chromatography uses supports in which electrically charged chemical groups are covalently attached. Interaction occurs between an isolate molecule carrying a charge (either positive or negative) and a sorbent carrying a charge opposite to that of the isolate. Ionexchange interactions are divided into cation (positively charged) and anion (negatively charged). Anionic groups include strong acids such as sulphonates, sulphates and phosphates and weak acids such as carboxylates. Cationic groups are represented by tertiary amino groups (weak) and quarternary amino groups (strong). All these chemical groups are attached to the support through a spacer by means of ether, alkylamine or amido bonds.

An affinity sorbent for affinity chromatography is prepared by the attachment of a defined ligand on an inert matrix by means of a chemical reaction. The support must be essentially inert to avoid non-specific binding which decreases the level of selectivity and must have chemical groups available where ligands can be chemically attached after treatment with activating agents. These groups are frequently hydroxyl groups, amido, carboxyl or amino groups to adapt immobilisation chemistry. Ligand coupling reactions most frequently involve nucleophilic attack. The coupling reaction should preferably be chosen so that biological inactivation of the ligand is avoided or minimised.

Adsorption chromatography can be best described by the polar interactions between the stationary phase and the functional groups on isolates. Polar interactions include hydrogen bonding, dipole/dipole, induced dipole/dipole, pi-pi and a variety of other interactions in which the distribution of electrons between individual atoms in the functional groups is unequal causing positive and negative polarity. Groups that exhibit these types of interactions typically include hydroxyls, amines, carbonyls, aromatic rings, sulfhydryls, double bonds and groups containing hetero-atoms such as oxygen, nitrogen, sulfur and phosphorus.

To attain resolution of enantiomers, several interactions are described between the chiral molecule and the stationary phase. Enantiomeric separations are for instance based upon the formation of inclusion complexes (cyclodextrins), attractive interactions or dipole stacking, hydrogen bonding and/or π−π interaction, hydrofobic interaction or diastereomeric metal complexes of isolate with the functional group of the stationary phase.

Surface bonded stationary phases or sorbents according to the invention can be prepared by chemical modification or physical adsorption of polymers. Chemical modification can be achieved by linking functional groups directly to the surface leading to monolayer bonded phases. The most efficient shielding of surfaces is obtained with polymer layers. Most reactions on silica, glass or on metal oxides involve the use of reactive hydroxyl groups present on the surface.

According to the invention, a suitable polymer is deposited and physically adsorbed on the sorbent, preferably a metal-oxide. Preferably, the physical adsorption step is followed by cross-linking, either between polymer chains or between polymer and sorbent surface in order to increase the stability or adhesion of the coated layer. A particular point to consider is the size of the polymer with regard to the pore size of the metal oxide particle and the affinity of the polymer for the surface of the metal oxide in the adsorption solvent. Higher affinity promotes better adhesion of polymer onto the metal oxide surface and, in most cases, a more homogeneous coating is provided. In general, the base support or core particles should be between 5 μm-3 mm in diameter, have a pore diameter of between 5-400 nm, a specific surface area of between 100-500 m2/g, be able to withstand pressures up to 300 bar and pH between 2-12.

In a preferred embodiment, the invention provides a sorbent wherein said polymer is hydrophilic. According to the invention suitable (organic) polymer is adsorbed directly to the surface of the sorbent, which adsorption for example occurs through Lewis acid-base interactions, electrostatic attraction, van der Waals forces and/or hydrogen bonding between the organic functional groups of the polymer and the surface of the inorganic polymer support material. To minimise nonselective adsorption, especially water-soluble, flexible hydrophilic polymers are used for this purpose. Typical useful hydrophilic polymers are polyethyleneimine or derivatives thereof, ethylenediamines or derivaties thereof, 1,3-diamino-2-hydroxypropane, diethylaminoethyl-modified dextrans and/or agaroses or derivatives thereof. Others can be selected from natural polymers such as polysaccharide, dextran, cellulose, alginate and agarose, and synthetic polymers such as polyacrylamide, poly(acrylic)acid, poly(methacrylic acid) and methyl, ethyl, propyl and butyl derivatives thereof, polystyrene and sulfonated derivatives thereof, amino-substituted polystyrenes, poly(4-hydroxy styrene), poly(vinyl alcohol), poly(ethylene oxide), polycarbonates, polyester, polyethylene, polypropylene, polybutylene, polyisobutylene, polyamides (such as nylon), poly(ethyleneglycol), hydroxylated cellulose derivatives, poly(vinylacetate), polymethacrylate and methyl, ethyl, propyl and butyl derivatives thereof, styrene-divinylbenzene, acrylamide-bisacrylamide, epoxy, polysulfone, polyethyleneterephthalate, urethanes, mono- and di-substituted vinyls, teflon, silicone and copolymers thereof.

Preferably, the invention provides a sorbent wherein said polymer at least comprises polyethyleneimine or another related hydrophilic polymers as indicated above, which can of course also be used as last layer over on of the other above mentioned polymers.

In a preferred method according to the invention it is provided to adjust the sorbent surface by coupling a polymeric layer onto the solid phase support by electrostatic attraction between the charged surface and the charged polymer, provided they carry opposite surface charges. Polymers which are suitable for this purpose are polyethyleneimine and for example dextran or agarose with dimethylaminoethyl groups which both carry positive charges that have been attached to the in general negatively charged metal-oxide surface. Owing to the self-assembling nature, adsorbed polyethyleneimine stationary phases were relatively simple to make and a variety of anion exchange media can be synthesised (see for examples also detailed description).

In yet another preferred embodiment the invention provides a polymer coated metal oxide sorbent wherein said metal oxide comprises alumina. Metal sorbent as provided by the invention have distinct advantages. Metal oxides such as alumina, titania or zirconia have a chemical stability that is in general much higher than that of silica. For instance, alumina is chemically more resistant than silica and dissolves only above pH>12 and under pH<3.

With the term “alumina” a class of compounds with the composition Al₂O₃·nH₂O, where n ranges from 0 to 3 is meant. Porous active alumina is well-known in the art and for instance employed as adsorbent and catalyst, and although as polar as silica, its surface chemistry is somewhat different due to the presence of Lewis acid and Lewis basic sites which is reflected by its chromatographic retention behaviour. An aqueous suspension of alumina has a pH of approximately 9 and, as a result, possesses cation exchange properties. This basic alumina can be converted to a ‘neutral’ or further to an ‘acidic’ alumina which then act as anion exchanger. Alumina preferentially retains organic compounds with carbon-carbon double bonds. For chromatographic applications, alumina is therefore frequently used as straight phase solid phase material.

Alumina, can be characterised as a support with high mechanical and physical stability. Thanks to the fact that alumina is relatively cheap and produced in large quantities, the material is frequently used for purification purposes on large scale. However, affinity separation with alumina-based sorbents has never been provided. An advantage of alumina above silica is its pH stability in a much wider range, a property which is (sometimes) necessary for (immuno)affinity chromatographical applications.

The invention also provides an anorganic sorbent, such as a silica, glass or metal oxide sorbent, having been provided with a functional moiety to allow coupling of said sorbent with an affinity ligand. One of the main criteria for selecting a suitable support for (immuno)affinity chromatographic applications is that the ligand is immobilised is such a way that it retains most of its biological properties and that the support itself does not contribute to non-selective absorption of the analyt of interest. Due to the properties of most rigid materials (polystyrene, as well as metal oxides), it must again be emphasised that, due to possible non-selective interactions, these materials cannot directly be used for (immuno)affinity chromatographic applications. Therefore, adjusting the surface of these materials in order to change their physical and chemical properties is in general needed prior to coupling of the ligand of interest. In order to be able to immobilise ligands of interest, further activation of the surface with a functional moiety is provided to provide coupling capacity of the ligand to said moiety. Activation can be defined as the process of chemically modifying a sorbent so that the product of the process, the functional moiety, will react to form a covalent bond with a ligand of choice. The method selected for activation of a sorbent is preferably compatible with both the ligand and the sorbent. Secondly, the method of activation is chosen such that high yields and rapid coupling is achieved; ligand leakage is minimised; unsuccessful coupling does not lead to non-specific absorption effects; and the activation does not alter the porosity or other properties of the matrix.

Furthermore, the invention provides a sorbent wherein to prevent leaching of the adsorbed polymer layer from the support and to produce a solvent and pH resistant support, the stability of the stationary phase obtained is increased by cross-linking of the adjacent organic groups of the adsorbed polymer. Additionally, a multifunctional crosslinking reagent comprising reactive groups which subsequently can be further derivatised using conventional techniques to produce chromatography materials useful for conducting (immuno) affinity, ion exchange, hydrophobic interaction and other forms of chromatographic separations may be used.

To further obtain a sorbent according to the invention, crosslinking can for example be achieved with compounds with the following general formula 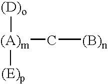
wherein A and B are functional groups on a crosslinker C that reacts with the functional groups of the adsorbed polymer and may be same of different, while m and n may vary from 1 to several hundred. Modification of the properties of the stationary phase is performed by the organic moieties D and E. The number of D and E ligands represented by 1 and p may vary from zero to several hundred in the crosslinking molecule. Crosslinking is preferably performed with a multifunctional peroxide (1,2-ethanediol diglycidyl ether, 1,4-butanediol diglycidyl ether, 1,3 diglycidylglycerol or triglycidylglycerol), a multifunctional anhydride (such as polyacrylic anhydride), an alkyl bromide (such as 1,3-dibromopropane) or a nitro alcohol (such as 2-methyl-2-nitro-1,3-propanediol).

To improve the motional freedom of the ligands, further derivatisation and the introduction of a spacer molecule is provided. Depending on the crosslinker used, residual reactive groups at the surface of the support are obtained which subsequently can be derivatised thereby using a defined spacer molecule and in combination with conventional techniques to produce chromatography materials useful for conducting affinity, cation exchange, anionic exchange, hydrophobic interaction and other forms of chromatographic separations.

Especially spacers that have more polar constituents, such as secondary amines, amide linkages, ether groups or hydroxyls will help keep hydrophobic effects at a minimum. Additionally, specific immobilisation chemistries can be constructed from the appropriate choice of spacer molecules. For instance, site-directed chemistry can be built on the end of the spacer and its length can aid in reaching the appropriate functionality on the ligand of interest. Most spacers are built from individual molecules no more than 10 atoms in length. They have appropriate coupling functionalities or coupling sites on either end and an overall hydrophilic character. Suitable spacer molecules as for example provided here are diaminodipropylamine (3,3′-iminobispropylamine), 1,6-diaminehexane, 6-aminocaproic acid, succinic acid, 1,3-diamino-2-propanol, ethylenediamine, hydrophilic amino acids (such as glycine, poly-L-glutamic acid, alanine, poly-L-aspartic acid, beta-alanine, cysteine, poly-L-lysine and homocysteine) and aminated epoxides (such as epichlorohydrin and 1,4-butanediol diglycidyl ether). To extend the length of the spacer arm, cyclic anhydrides (such as succinic anhydride and glutaric anhydride, containing a 4- and 5-carbon chain) are used. Spacer molecules useful in these various types of separation typically are attached through the residual reactive groups accessible on the crosslinked coating using chemistries well known, and may for example be further to provided them with functional moieties by treatment with: 1) polyethers of various lengths to produce swellable hydrophilic tentacles extending from the substrate's surface; 2) alkanols to produce ether linked hydrocarbons of various lengths ranging, for example, from C4 to C20; 3) polyethyleneimine to produce a cationic resin (anion exchanger) which itself may be derivatised further; 4) tertiary amines (e.g.: N(CH3)2) to produce strong anionic exchange resins; 5) diethanol amine to produce weak anionic exchange resins; 6) alpha hydroxy alkyl sulphonates to produce strong cationic exchange resins; 7) hydroxyacetic acid to produce a weak cationic exchange resin; 8) imino-diacetic acid to produce a metal chelate resin; and 9) various combinations of the foregoing. Other affinity ligands, such as antibodies, (receptor) proteins, enzymes and other biological and synthetic molecules may be immunochemically, electrostatically or covalently coupled to the coatings using procedures known per se.

The invention furthermore provides an anorganic sorbent coated with a polymer according to the invention wherein said functional moiety comprises for example hydrazide or aldehyde. An hydrazide activated support as provided by the invention is preferably used to immobilise a variety of glycoproteins. Hydrazide immobilisation chemistry permits the coupling of aldehyde- or ketone-containing ligands through the formation of stable hydrazone linkages. Since the hydrazone bonds are stable without the use of reductants, sensitive proteins are more likely to retain activity after immobilisation. Secondly, it was found that the immobilisation of antibodies to a hydrazide group containing sorbent revealed the highest retention of antigen binding activity. Site-directed immobilisation of antibodies as provided by the invention, in which the antibody is coupled in such a way that the molecule can be oriented on the support so its bivalent binding potential for antigen can be realised fully, is allowed by hydrazide activation chemistry, which is especially useful in this regard. The method takes advantage of the carbohydrate chains coming off the heavy chains in the CH2 domain. Mild oxidation of the sugar residues of the antibody using sodium periodate will generate formyl groups which then can be used to immobilise the antibody specifically through these modified carbohydrate residues. Generally, this method results in the coupling of intact antibody molecules and usually gives the highest yield of antigen binding site activity.

At least two methods are available to make a hydrazide-containing support. In the first procedure, an aldehyde-containing sorbent is generated by oxidation with sodium periodate. This intermediate is then reacted with adipic dihydrazide to produce the active hydrazide-containing support. This procedure in general results in a sorbent that is highly cross-linked when the adipic dihydrazide is coupled. In a second procedure, a spacer arm is initially coupled to the matrix, leaving a terminal carboxyl group. Adipic dihydrazide is then coupled to this sorbent using the EDC conjugation chemistry. This spacer provides greater steric accommodation needed for antibodies and is relatively hydrophilic to prevent non-selective adsorption. This latter procedure is preferred for the activation of the modified polymer coated sorbent such as polymer coated alumina.

In addition, in particular for the purpose of affinity chromatography, an aldehyde activated support is provided. Similar chemistries can be used, however, if in a preferred embodiment glycidol is coupled to the material followed by mild oxidation by means of sodium periodate to give the aldehyde activated sorbents. Via this way ligand coupling is relatively simple and in the presence of sodium cyanoborohydride stable amide bonds are formed between the sorbent and the ligand of interest.

Based on the properties of polymer coated sorbents such as the metal oxide sorbents as provided by the invention having good pH stability as well as adequate mechanical and physical stability and large availability against low costs, and the possibility to circumvent possible non-selective interaction by the adsorption of a polymer such as polyethyleneimine, further strategies are provided to activate this modified sorbent in order to couple ligands of interest (antibodies, enzymes, receptors, proteins, etc.).

The invention also provides a method for providing a sorbent having been provided with a polymer coating to prevent non-selective adsorption with a desired coupling capacity for an affinity ligand comprising providing said sorbent with a functional moiety to allow coupling of said sorbent with an affinity ligand. For example the invention provides a method to provide a polymer coated silica sorbent with a functional moiety which comprises for example hydrazide or aldehyde, linked to said sorbent as described above. In a preferred embodiment, said coated silica sorbent is coated with a hydrophilic polymer which comprises polyethyleneimine. Furthermore, the invention provides polymer coated sorbents having been provided with an affinity ligand, for example wherein said ligand comprises a protein or a glycoprotein. Such polymer coated sorbents, having been provided with a functional moiety to couple an affinity ligand, are particularly useful to couple for example an antibody. Such sorbents as provided by the invention are preferably used as packing material for a molecule separation unit, such as a chromatography column for, for example, high-performance liquid chromatography (HPLC).

The invention also provides a molecule separation unit comprising a sorbent according to the invention, such as a column packed with a polymer coated sorbent. Such a molecule separation unit as provided by the invention in particular suitable for large scale separation, for example comprises a fluidised bed wherein for instance fermentation broth or another medium is fed through a floating bed which will not or only little clog; after the molecule of interest is adsorbed and the bed is saturated, the molecule of interest can be efficiently desorbed and the bed can be reused for another round of Fluidized Bed Chromatography.

In particular the invention provides a chromatography column for for example Column Chromatography or Radial Flow Chromatography (Radial Flow columns are eluted in radial direction). Such units are preferably used in a method as provided by the invention (see also the detailed description) for determining the presence of a substance in a sample comprising submitting said sample to a molecule separation unit according to the invention, separating at least part of said substance from said sample by at least partly retaining it in said unit, further comprising eluting said substance from said unit and determining the presence of said separated substance in the eluted fraction, preferably further comprising separating at least part of said substance from said sample by at least partly retaining said substance in said unit. In such a method as provided said desired substance is retained by affinity of said substance to an affinity ligand, the method further comprising eluting said retained substance from said unit.

The invention is further explained in the detailed description without limiting the invention thereto.

### DETAILED DESCRIPTION

Apparatus

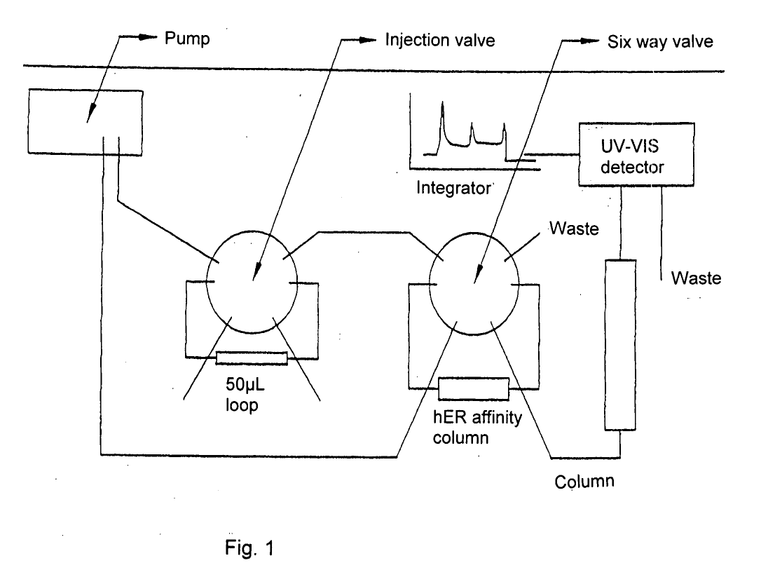

In order to test the columns and develop assays based on two-dimensional chromatography, a model 110B liquid chromatograph equipped with a model 163 variable UV-VIS detector (Beckman) or a model DECADE electrochemical detector (Antec Leyden, Leiden) was used. Injection was carried out by means of a model 210A Sample Injection Valve (Beckman, Leiden). The peaks were monitored by means of a model Chrom-Jet integrator (Interscience, Breda). The (immuno)affinity column was coupled on- and off-line with the analytical system by means of a Rheodyne two-position six-way valve (Bester, Amsterdam). See FIG. 1 for a possible instrumental set up.

Materials

Chemicals for the synthesis of modified and activated alumina

| | |
|---|---|
| Alumina N, Aktive I (63-200 um) | ICN Biomedicals |
| Poly(acrylic acid) sodium | Brunschwig |
| PET-18 solution | Brunschwig |
| N,N-dimethylformamide | J. T. Baker |
| Methanol | J. T. Baker |
| Aceton | J. T. Baker |
| Triethylamine | Sigma |
| N,N′-carbonyl diimidazole (CDI) | Sigma |
| N,N-diisopropylamine | Sigma |
| Diaminodipropylamine | Sigma |
| Succinic anhydride | Sigma |
| Adipic dihydrazide | Sigma |
| 1-ethyl-3-(3-dimethylaminopropyl)carbodiimide (EDC) | Sigma |
| MES free acid | Sigma |
| Sodium hydroxide | Sigma |
| Glycidol | Sigma |
| sodium-meta-periodate | Sigma |
| sodiumcyanoborohydride | Sigma |

Chemicals for the coupling of ligand and final assays

| | |
|---|---|
| sodium-meta-periodate | Sigma |
| sodiumcyanoborohydride | Sigma |
| disodium hydrogen phosphate | Sigma |
| potassium dihydrogen phosphate | Sigma |
| sodium chloride | Sigma |
| Hydrochloric acid | E. Merck |
| Potassium thiocyanate | E. Merck |
| water (HPLC grade) | Labscan |
| methanol | J. T. Baker |
| Isopropanol | J. T. Baker |

Standards and ligands

| | |
|---|---|
| β-Estradiol | Sigma |
| Vitamin B12 | Sigma |
| Glucose | E. Merck |
| Butylbenzylphthalate | gift from |
| | R.I.V.M. |
| Bis(2-ethylhexyl)phthalate | gift from |
| | R.I.V.M. |
| 3-OH-bis-(ethylhexyl)-phthalate | gift from |
| | R.I.V.M. |
| Anti-estradiol | Biogenesis |
| Anti-vitamin B12 | Sigma |
| Glucose oxidase | Boehringer |
| | Mannheim |
| Human Estrogen Receptor (hER) | ABR Inc. |

Experiments
Preparation of Coated Alumina

Prior to modification of the alumina, polyacrylic anhydride was synthesised by weighing 10 gram of polyacrylic acid into a 100 mL flask and placing this in a oil batch at 180° C. for 3 hours. A stream of nitrogen flushed the surface of the solid during heating.

Alumina (4 g) was suspended in 90 mL methanol containing 6 mL of PEI-18 solution. The suspension was stirred at 30° C. for 4 hours. The PEI-coated alumina was filtrated on a G4 glass filter, washed with dry N,N-dimethylformamide and dried under vacuum. The PEI-coated alumina was cross-linked by suspending the material obtained in 25 mL of dry N,N-dimethylformamide, containing 1,5 mL of dry N,N-diisopropylamine and 500 mg of polyacrylic anhydride. The reaction was completed by stirring the suspension overnight at 60 C. The resulting media was filtrated on a G4 glass filter and washed with methanol, triethylamine and N,N-dimethylformamide.

Preparation of Hy Activated Alumina

Coupling of N,N-Carbonyl Diimidazole

The PEI-coated material was suspended in 10 mL of N,N-dimethylformamide containing 1 g of N,N-carbonyl diimidazole. The reaction was completed by stirring the suspension for 1 hour at 30° C. The product obtained was isolated on a G4 glass filter and was washed with N,N-dimethylformamide and acetone.

Introducing a Spacer (Diaminodipropylamine)

Diaminodipropylamine (1 g) was dissolved in 5 mL of acetone. Towards this solution the product obtained under A. was added and the suspension obtained was allowed to react for 3 hours at room temperature by stirring. The product was isolated on a G4 glass filter and was washed with acetone, water, 1 M NaCl and water.

Introducing an anhydride function (succinic anhydride)

The product obtained under B. was suspended in 4 mL of water containing 0,5 g of succinic anhydride. The reaction was allowed to complete by stirring for 1 hour at 30° C. The product obtained was isolated on a G4 glass filter and was washed with water, 1 M NaCl and water.

Activation with Adipic Dihydrazide

The product obtained under C. was washed with 0,1 M MES buffer pH 4,75 and is added to 4 mL of 0,5 M adipic dihydrazide in 0,1 M MES buffer pH 4,75. Towards this suspension, 0,12 g of EDC was added and reaction was allowed to complete by stirring for 3 hours at room temperature. The product obtained was isolated on a G4 glass filter and was washed with water, 1 M NaCl and water.

Preparation of Aldehyde Activated Alumina

Coupling of N,N-Carbonyl Diimidazole

The PEI-coated material was suspended in 10 mL of N,N-dimethylformamide containing 1 g of N,N-carbonyl diimidazole. The reaction was completed by stirring the suspension for 1 hour at 30° C. The product obtained was isolated on a G4 glass filter and was washed with N,N-dimethylformamide and acetone.

Introducing a Spacer (Diaminodipropylamine)

Diaminodipropylamine (1 g) was dissolved in 5 mL of acetone. Towards this solution the product obtained under A. was added and the suspension obtained was allowed to react for 3 hours at room temperature by stirring. The product was isolated on a G4 glass filter and was washed with acetone, water, 1 M NaCl, water and 1 N NaOH.

Activation with Glycidol

The product obtained under B. was suspended in 4 mL of 1,0 N NaOH containing 0,4 mL of glycidol and 10 mg of sodium borohydride. The reaction was allowed to complete by stirring overnight at room temperature. The product obtained was isolated on a G4 glass filter and was washed with water, 1 M NaCl and water.

Introducing the Aldehyde Function

The product obtained under C. was suspended in 4 mL of 0,2 M sodium metaperiodate. The reaction was allowed to complete by stirring for 90 minutes at room temperature. The product obtained was isolated on a G4 glass filter and was extensively washed with water.

Coupling of Ligands

Coupling of Anti-Estradiol

Anti-estradiol (200 μg) was dissolved in 500 μL 0,1 M phosphate buffer pH 7,0. Towards this solution 10 mg of sodium periodate was added and dissolved by gently mixing. The reaction was allowed to stand for 30 minutes at 4° C. in the dark. The solution was desalted by ultrafiltration at 5000 g for 30 minutes at 4° C. with a Centrisart C30 filter. The pellet obtained was dissolved in 1 mL of 0,1 M phosphate buffer pH 7,0 and was added to 1,4 g of HY actived alumina washed prior with 0,1 N phosphate buffer pH 7,0. The reaction was allowed to complete by stirring overnight at room temperature. The anti-estradiol coupled media was finally washed with 0,1 M phosphate buffer pH 7,0.

Coupling of Anti-Vitamin B12

Anti-vitamin B12 (150 μg) was dissolved in 500 μL 0,1 M phosphate buffer pH 7,0. Towards this solution 10 mg of sodium periodate was added and dissolved by gently mixing. The reaction was allowed to stand for 30 minutes at 4° C. in the dark. The solution was desalted by ultrafiltration at 5000 g for 30 minutes at 4° C. with a Centrisart C30 filter. The pellet obtained was dissolved in 1 mL of 0,1 M phosphate buffer pH 7,0 and was added to 1,4 g of HY actived alumina washed prior with 0,1 N phosphate buffer pH 7,0. The reaction was allowed to complete by stirring overnight at room temperature. The anti-vitamin B12 coupled media was finally washed with 0,1 M phosphate buffer pH 7,0.

Coupling of Glucose Oxidase

Glucose oxidase (1 mg) was dissolved in 1 mL of 0,1 M phosphate buffer pH 7,0. Towards this solution 1,4 gram of washed prior with 0,1 M phosphate buffer pH 7,0 aldehyde activated alumina was added and 10 mg of sodium cyanoborohydride. The reaction was allowed to complete by stirring overnight at room temperature. The glucose oxidase coupled media was finally washed with 0,1 M phosphate buffer pH 7,0.

Coupling of her Receptor

Human Estrogen Receptor (hER) (50 μg) was dissolved in 1 mL of 0,1 M phosphate buffer pH 7,0. Towards this solution 1,4 gram of washed prior with 0,1 M phosphate buffer pH 7,0 aldehyde activated alumina was added and 10 mg of sodium cyanoborohydride. The reaction was allowed to complete by stirring overnight at room temperature. The hER coupled media was finally washed with 0,1 M phosphate buffer pH 7,0.

Packing of the Supports

The supports obtained were packed in 50×4,6 mm empty PEEK columns at a flow rate of 10 mL/min with water as eluens. Suspensions were made in water, whereas packing was performed according to the procedures described by Boehringer Mannheim for packing of media with the Self Packing Device.

RESULTS

Preliminary experiments were conducted coat alumina the conventional way by using y-glycidoxypropyl trimethoxysilane as coating reagent. After coating, the gel was activated with sodium periodate and anti-estradiol was coupled via cyanoborohydride. Although it seemed that the immunoaffinity column effectively captured the estradiol, a blank column showed similar affection for estradiol. Based on these results it was concluded that the alumina surface was not adequately shielded leading to non-selective adsorption of the analyt of interest. Coating of alumina with a hydrophilic polymer, such as polyethyleneimine, provided a much better selectivity. After coating the alumina with PEI-18 and cross-linking with polyacrylic anhydride as described above, the media was tested for non-selective adsorption of apolar components (here estradiol or testosterone were used and polar components (vitamin B12). Batch experiments were carried out by adding standard solutions in 0,1 M phosphate buffer pH 7,0 to modified alumina. After incubation, the upper standing liquid was analysed by RP-HPLC on the content of the standard added. By comparing the results with those of a direct injection of the standard solution, it was found that no non-selective adsorption of the above mentioned compounds was observed. Based on these findings, it was decided to proceed with the activation of the modified alumina.

For the activation of the modified alumina, two different procedures were developed; one for the site-directed immobilisation of antibodies (the hydrazide activated alumina) and one for the immobilisation of for instance enzymes, proteins, receptors etc. (the aldehyde activated alumina). Experiments with covalent coupling of antibodies or other proteins directly to the surface of N,N carbonyl diimizole activated coated alumina provided sorbents with coated ligand. However, the introduction of spacers provided higher ligand accessibility, providing the sorbents with high capacities to bind ligands of interest. With spacers, both activated media was again tested for non-selective adsorption of estradiol, testosterone, vitamin B12 respectively estradiol. In this case batch experiments as mentioned above as well as blank columns were tested for non-selective adsorption. However, in neither case non-selective adsorption of the analytes was observed.

Based on these results it was decided to proceed. Several ligands were coupled and the chromatographical conditions of the assays developed were determined.

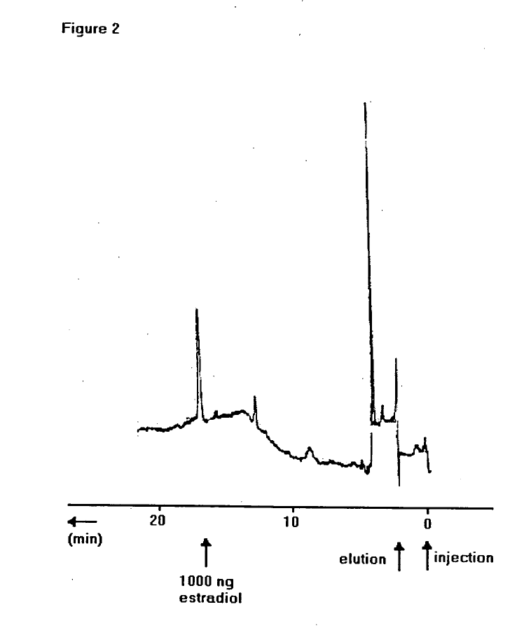

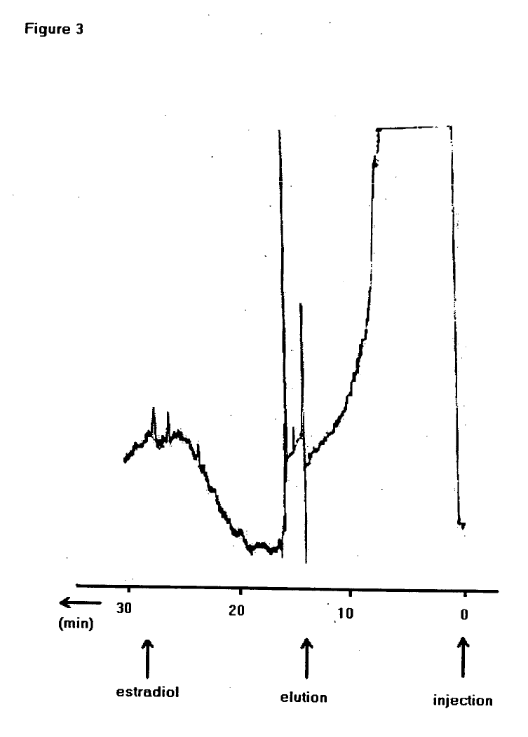

With respect to the first assay, the determination of estradiol by means of immunoaffinity in combination with RP-HPLC, chromatographical conditions were determined on forehand. Separation of estradiol by means of RP-HPLC took place with 80% v/v methanol at a flow rate of 1 ml/min. By coupling via a six-way valve the immunoaffinity column on- and off-line with the analytical system, breakthrough versus capturing of estradiol by the immunoaffinity column could be determined (see FIG. 1). Based on the fact that no breakthrough of estradiol was found, it was concluded that estradiol was quantitatively captured by the immunoaffinity column. Elution of an antigen, however, is a matter of trial and error. Finally, it was found that quantitative elution of estradiol was possible by means of 80% v/v methanol. A typical chromatogram obtained after capturing, elution and analysing estradiol by means of immunoaffinity in combination with RP-HPLC is shown in FIG. 2. By analysing standard solutions of estradiol according to the conditions mentioned in the capture of FIG. 2, it was found that up to 2 μg of estradiol was quantitatively captured. The mean recovery of estradiol was found to be approximately 80% for all standard solutions analysed (200-1000 ng/mL of estradiol). The precision of the method was determined by analysing a standard solution of 200 ng/mL of estradiol six times. The repeatability, expressed as the relative standard deviation in the peak heights measured, was found to be 4%. Linearity of the method was found to be up to 2000 ng/mL of estradiol. Selectivity of the assay was determined by analysing a serum sample containing a variety of hormones. Although the immobilised antibody did show cross-reactivity (see FIG. 3), estradiol could be determined accurately thanks to the additional separation by means of RP-HPLC.

Regarding the stability of the immunoaffinity column, the column was stored at 4° C. and tested again for its capacity after 6 months of storage. By comparing the results with those obtained with the column a half year ago, it was concluded that the immunoaffinity column remained its activity and that no significant degradation of the immunoaffinity column had taken place after six months of storage at 4° C.

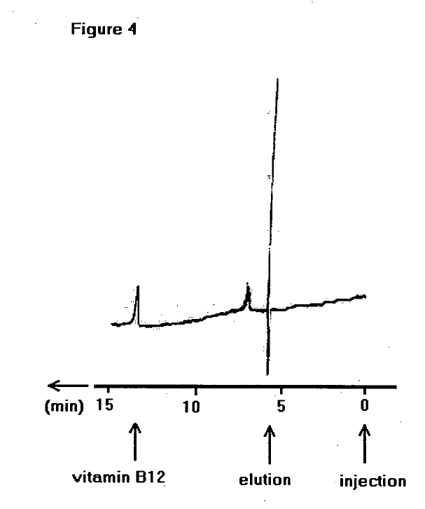

A second assay based on immunoaffinity in combination with RP-HPLC was developed by coupling anti-vitamin B12 to hydrazide activated alumina. After packing the material, the immunoaffinity column was tested for its capacity on capturing vitamin B12. Therefore a standard solution of 19,9 mg/L of vitamin B12 was injected and the breakthrough respectively capturing of vitamin B12 was analysed. It was found that vitamin B12 was quantitatively captured by the immunoaffinity column. With respect to the elution conditions, it was found that vitamin B12 was quantitatively eluted by means of 30% v/v methanol and 70% v/v water containing 500 μL of concentrated HCL+150 mM NaCl per L water. The precision of the method was determined by analysing a standard solution of 7,96 μg/mL of vitamin B12 six times. The repeatability, expressed as the relative standard deviation in the peak heights measured, was found to be 4%. Linearity of the method was found to be up to 10 mg/L of vitamin B12. At a concentration of 20 mg/L and 40 mg/L breakthrough of vitamin B12 was observed. The accuracy and/or selectivity of the assay was determined by analysing two fermentation broth samples. By comparing the results with the theoretically values, it was concluded that the method is accurate and selective for the determination of vitamin B12 in fermentation broth. An example of a chromatogram together with the chromatographic conditions is demonstrated in FIG. 4.

To examine whether or not enzyme or protein could be coupled on an aldehyde activated alumina without loosing its activity, it was chosen to couple glucose oxidase in order to determine glucose by means of Flow Injection Analysis (FIA) in combination with electrochemical detection. Glucose oxidase converts glucose in gluconolactone and H2O2. The hydrogenperoxide generated in this reaction can electrochemically be determined on a platinum electrode which is polarised at +500 mV vs. an Ag/AgCl electrode. At a flow rate of 0,5 mL/min, standard solutions of glucose were injected onto the column and it was found that up to 50 mM glucose, determination of glucose was possible via this way. From these results it was concluded that biomolecules could be coupled to activated metal oxide, e.g. aluminium, without loosing their biological activity.

Next, based upon the results mentioned above, human Estrogen Receptor (hER) was coupled to the aldehyde activated affinity media. It is well known that microcontaminants in the environment can initiate several biological effects, for instance after binding to receptors. At the moment, the estradiol receptor gains an increased interest in environmental research and health control. This receptor binds estradiol and regulates the concentration of estradiol in the blood of organisms. Estradiol is a female hormone and plays an important role in the reproduction of mammals as well as fishes. More and more studies points out the presence of microcontaminants in the environment which exhibit affinity with this receptor and affecting in a negative way the reproduction of several species in the environment. World-wide the interest in these so-called xeno-estrogenic compounds increases but only a limited amount of tests are available to screen and identify compounds for their estrogenic activity. By coupling human Estrogen Receptor to a solid phase support, analytes of interest can be selectively isolated from the matrix by means of their biological activity. Compounds with xeno-estrogenic activity will be captured by the hER affinity column, whereas compounds which do not show xeno-estrogenic activity will not be captured by the hER affinity column. Finally, quantitative analysis of the compounds captured can be carried out by means of RP-HPLC.

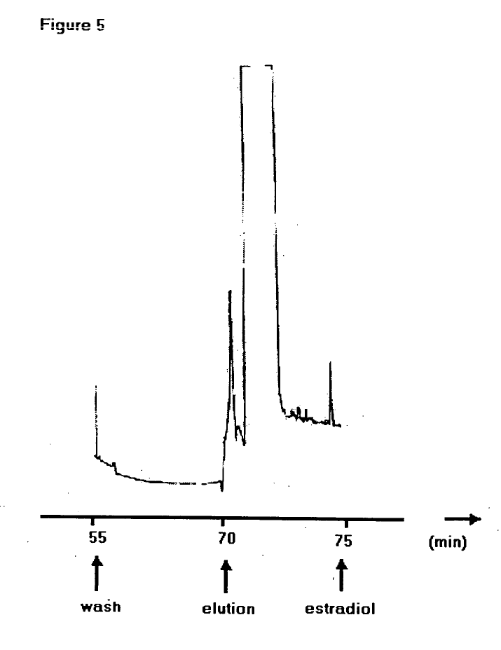

So, in order to develop such an assay, the hER affinity media produced as described above was packed and tested for its capacity. Again, by coupling via a six-way valve the hER-affinity column on- and off-line with the analytical system, breakthrough versus capturing of estradiol by the hER-affinity column could be determined (see FIG. 1). Injection of a standard solution of 4 mg/L of estradiol demonstrated no breakthrough of estradiol, and it was concluded that estradiol was quantitatively captured by the hER-affinity column. Quantitative elution of estradiol from the affinity column was found to be possible with 25% v/v 6 M KSCN/50% v/v water/25% v/v methanol. Elution of estradiol from the analytical column was possible with 65% v/v methanol. An example of a typical chromatogram and of the chromatographic conditions used is given in FIG. 5. To examine whether or not the column could distinguish between compounds with or without xeno-estrogenic activity several detergents were analysed with the assay described here. It was found that a detergent, butylbenzylphthalate with only slightly xeno-estrogenic acitivity, was captured for only 6%, whereas bis(2-ethylhexyl)phthalate, a detergent which is know to exhibit xeno-estrogenic activity, was captured quantitatively. Its possible metabolite, 3-OH-bis-(ethylhexyl)-phthalate was captured for only 22%. Based on these results it was decided to proceed with the testing of more chemicals on their possible xeno-estrogenic activity by the method presented here. By comparing the results with those obtained with in vivo tests, we will try to establish a validated method for the fast screening of chemicals on their xeno-estrogenic activity

Coating of metal oxides the conventional way via organosilane chemistry does not lead to the required characteristics; the materials maintain their character and undesirable non-selective adsorption remains. Coating with hydrophilic polymers via electrostatic attraction alters the characteristics of the supports significantly; no non-selective adsorption of nonpolar or polar compounds such as testosterone or estradiol respectively vitamin B12 was observed. Via this way it is possible to use metal oxides alumina as solid phase support for the production of (immuno)affinity columns which can be used in combination with conventional HPLC. The production of these materials is relatively cheap compared to polymer based materials and has the advantage of conventional high pressure liquid chromatography solid phase materials such as resisting high pressures and organic solvents.

For the immobilisation of affinity ligands such as antibodies, site-directed coupling is preferred. For an efficient coupling of for example the antibody via site-directed immobilisation, the use of a spacer is required. Using the spacer diaminodipropylamine in combination with succinic anhydride does not lead to non-selective adsorption of apolar or polar compounds like estradiol or testosterone respectively vitamin B12. Immobilisation through site-directed immobilisation by activation the support via adipic dihydrazide demonstrated to give good results. Alternatively, activation through bonding via Protein A or G, e.g. coupled as ligand to aldehyde activated alumina is provided.

Coupling of ligands via the amide bond of aldehyde activated alumina demonstrated to give reliable affinity media. Although, thanks to the stable amide formed during the coupling, this strategy is frequently used for most applications, other coupling procedures are worthwhile to investigate.

Packing materials for other modes of chromatography are provided likewise, e.g. by coating a particle with a hydrophilic polymer, crosslinking, introducing a spacer followed by coupling of a functional moiety. For example, ion exchange materials are provided by covalently coupling a weak cation, e.g. sulfanilic acid, respectively a strong cation, e.g. benzenesulfonic acid and quaternary ammonium salt.

Figure Legends

FIG. 1: Schematic presentation of the instrumental set-up

FIG. 2 Analysis of a standard solution of estradiol by two-dimensional chromatography

Conditions:

Column 1: Anti-estradiol column
Column 2: ICN Sperica RP C18, 5 μm, 50 A (250×4 mm)
Temperature: ambient
Solvent A: 0,01 M phosphate buffer pH 7,0
Solvent B: 80% v/v Methanol
Flow: 1 mL/min
Injection: 1 mL
Detection: UV-VIS at 230 nm

Time program

| Step | Time(min) | Column 1 | Column 2 | % A | % B |
|---|---|---|---|---|---|
| Loading | 0-5 | on-line | off-line | 100 | 0 |
| Elution | 5-20 | on-line | on-line | 0 | 100 |

| | | |
|---|---|---|
| Equilibration | 20-35 | lysis of a standard reference |

Analysis of a serum sample by two-dimensional chromatography (chromatographic conditions: see FIG. 2)

The serum sample contains besides estradiol, estriol, cortisol, aldosterone, progesterone, testosterone and 17-hydroxyprogesterone.

FIG. 4: Analysis of a standard solution of vitamin B12 by two-dimensional chromatography

Conditions:

Column 1: Anti-vitamin B12 column
Column 2: ICN Sperica RP C18, 5 μm, 50 A (250×4 mm)
Temperature: ambient
Solvent A: 0,01 M phosphate buffer pH 7,0
Solvent B: 30% v/v methanol and 70% v/v water containing
500 μL concentrated HCL per Litre+150 mM NaCl
Flow: 1 mL/min
Injection: 50 μL
Detection: UV-VIS at 361 nm

Time program

| Step | Time(min) | Column 1 | Column 2 | % A | % B |
|---|---|---|---|---|---|
| Loading | 0-5 | on-line | off-line | 100 | 0 |
| Elution | 5-15 | on-line | on-line | 0 | 100 |
| Equilibration | 15-25 | on-line | off-line | 100 | 0 |

FIG. 5: Analysis of a standard solution of β-oestradiol (peak 1) after being capture and eluted by the hER-affinity column.

Conditions

Column 1: hER affinity column
Column 2: Zorbax XDB-C8 column
Temperature: ambient
Solvent A: 0,01 M phosphate buffer pH 7,0
Solvent B: 25% v/v 6 M KSCN, 50% v/v solvent A and methanol
Solvent C: water
Solvent D: 65% v/v methanol
Flow: 0,5 mL/min
Injection: 50 μL
Detection: UV-VIS at 280 nm

Time program

| | Time | | | | | | |
|---|---|---|---|---|---|---|---|
| Step | (min) | Column 1 | Column 2 | % A | % B | % C | % D |
| Loading | 0 | on-line | off-line | 100 | 0 | 0 | 0 |
| Elution | 10 | on-line | on-line | 0 | 100 | 0 | 0 |
| Washing | 20 | on-line | on-line | 0 | 0 | 100 | 0 |
| Separation | 50 | off-line | on-line | 0 | 0 | 0 | 100 |

1. A packing material comprising an inorganic sorbent for use in affinity separation of molecules, said sorbent comprising silica, alumina or zirconia, a cross-linked polyethyleneimine coating to prevent non-selective adsorption and a spacer molecule which comprises a coupling site.

2. A packing material according to claim 1 wherein said sorbent comprises alumina.

3. A packing material according to claim 1 provided with a functional moiety to allow coupling of said sorbent with an affinity ligand.

4. A packing material according to claim 3, wherein said functional moiety comprises hydrazide or aldehyde.

5. A packing material according to claim 1 further having been provided with an affinity ligand.

6. A method for providing a packing material according to claim 3, wherein the inorganic sorbent is provided with the functional moiety for coupling of said sorbent with an affinity ligand.

7. Use of a packing material according to claim 1 in affinity separation of molecules.

8. Use of a packing material according to claim 7, wherein said separation comprises chromatography.

9. Use according to claim 8, wherein said chromatography comprises high-performance liquid chromatography (HPLC).

10. Use of the packing material according to claim 1 in a chromatography column.

11. A chromatography column comprising a sorbent according to claim 1.

12. A method for determining the presence of a substance in a sample comprising submitting said sample to a chromatography column according to claim 11, separating at least part of said substance from said sample by at least partly retaining it in said unit, further comprising eluting said substance from said unit and determining the presence of said separated substance in the eluted fraction.

13. A method for separating a substance present in a medium from said medium comprising submitting said medium to a chromatography column according to claim 11 and separating at least part of said substance from said sample by at least partly retaining said substance in said unit.

14. A method according to claim 12 wherein said substance is retained by affinity of said substance to an affinity ligand.

15. A method according to claim 14 further comprising eluting said retained substance from said chromatography column.

16. A packing material according to claim 2 provided with a functional moiety to allow coupling of said sorbent with an affinity legend.

17. A method for providing a packing material according to claim 4, wherein the inorganic sorbent is provided with the functional moiety for coupling of said sorbent with an affinity ligand.

18. A method according to claim 13 wherein said substance is retained by affinity of said substance to an affinity ligand.

19. A packing material comprising an inorganic sorbent for use in affinity separation of molecules, said sorbent comprising alumina, a cross-linked polyethyleneimine coating to prevent non-selective adsorption and a spacer molecule which comprises a coupling site.

20. A packing material according to claim 19 provided with a functional moiety to allow coupling of said sorbent with an affinity ligand.

21. A packing material according to claim 20, wherein said functional moiety comprises hydrazide.

22. A packing material according to claim 19 further having been provided with an affinity ligand.
